(19) United States
(12) Patent Application Publication
(10) Pub. No.: US 2005/0251798 A1
(43) Pub. Date: Nov. 10, 2005

(54) System and method for inventory control and management

(75) Inventor: James J. Fraley, Encinitas, CA (US)

Correspondence Address: HOGAN & HARTSON L.L.P., 500 S. GRAND AVENUE, SUITE 1900, LOS ANGELES, CA, 90071-2611, US

(73) Assignee: News, IQ, Inc.

(21) Appl. No.: 10/889,755

(22) Filed: Jul. 12, 2004

Related U.S. Application Data
(60) Provisional application No. 60/568,444, filed on May 5, 2004.

(51) Int. Cl. G06F 9/44

(52) U.S. Cl. 717/168

(57) ABSTRACT

A system for inventory control and management. Software resident on a packaged electronic device is updated, patched or replaced without the need to remove the device from its package. A data path is provided from the electronic device inside the package to the exterior of the package for coupling with a field device, which is then able to download the software to the device without its removal from its package. The data path may be a wired or wireless link.

### RELATED APPLICATION

This application claims priority from U.S. provisional application No. 60/568,444, entitled “System and Method for Inventory Control and Management”, filed on May 5, 2004.

### FIELD OF THE INVENTION

The present invention relates to electronic devices with embedded software and, in particular, relates to a system and method for updating, upgrading or otherwise modifying the embedded software.

### BACKGROUND OF THE INVENTION

Electronic devices, such as mobile phones, personal digital assistants (PDAs), set top boxes and the like, typically contain application software or firmware, which are computer programs stored in memory for controlling or affecting operation of the device. As the sophistication of electronic devices increases, so does the frequency of updates and revisions to software contained in the devices. Software is typically replaced in whole or in part by a major update or new version once every few years, or more. In addition, as soon as a software product is released, errors or “bugs” are typically discovered that must be fixed. Rather than complete replacement of the software, minor bugs and errors are typically fixed via a software “patch”. Hence, once an electronic device containing application software or firmware is released, that software will need occasional major updates or replacement, as well as numerous fixes or patches.

The time period from the packaging of an electronic device to the opening of the package by a consumer may vary from several weeks to several months to a year or more. During this time, it is extremely likely that numerous fixes or patches to the software will be required, and relatively likely that complete replacement of the software by a new version or update will be required. Moreover, electronic devices may be initially shipped with generic software, with customer- or carrier-specific software to be installed at the point of distribution in the field. The provision of multiple software patches and revisions to devices that are already packaged and in the field poses a substantial problem. The packaged devices may be, for example, sitting on a pallet in a warehouse or on a shelf at a retail outlet.

Presently, few attractive options exist for updating or replacing software in packaged electronic devices. One option is to physically remove the devices individually from their packaging, upload the new software to the devices, and return the devices to their packaging. Not only is this method of updating software inefficient and time consuming, updated devices are not returned to their proper boxes at an error rate of approximately 2%. In the case of cellular telephones, for example, it is important that the phone be returned to its matching package as the package may contain information or indicia necessary to activate or use the phone. As mentioned, software often must be updated numerous times while the device is in the field, requiring significant and frequent manpower to implement the updates and increasing the chances for error. Another option is a product recall which, of course, is a costly and very unattractive option.

### SUMMARY OF THE INVENTION

The present invention provides a system and method for inventory control and management. In particular, it provides a system and method for updating software that is resident on a packaged electronic device without the need to remove the device from its package.

One embodiment of the invention is a system for modifying software embedded in a packaged electronic device. A communications path extends from the electronic device to the exterior of a package containing the electronic device, and is configured for coupling to an external device for receipt of modified software.

Another embodiment of the invention is a system for managing an inventory of packaged electronic devices with resident software. A communications path extends from the resident software to the exterior of a package containing the electronic device, and is configured for coupling to an external communications device.

Another embodiment of the invention is a method for updating software contained in a packaged electronic device. A field device containing a software update is coupled to a communications path extending through a package that contains the electronic device. Without removing the electronic device from the package, the software update is downloaded to the electronic device.

### BRIEF DESCRIPTION OF THE DRAWINGS

FIG. 1 is a block diagram illustrating a system according to the present invention.

FIG. 2 is a block diagram illustrating the components of FIG. 1 in more detail.

### DETAILED DESCRIPTION OF THE INVENTION

The present invention provides a system and method for inventory control and management. In particular, it provides a system and method for updating software that is resident on a packaged electronic device without the need to remove the device from its package. A data path is provided from the electronic device inside the package to the exterior of the package for coupling with a field device, which is then able to download the software to the device without its removal from its package.

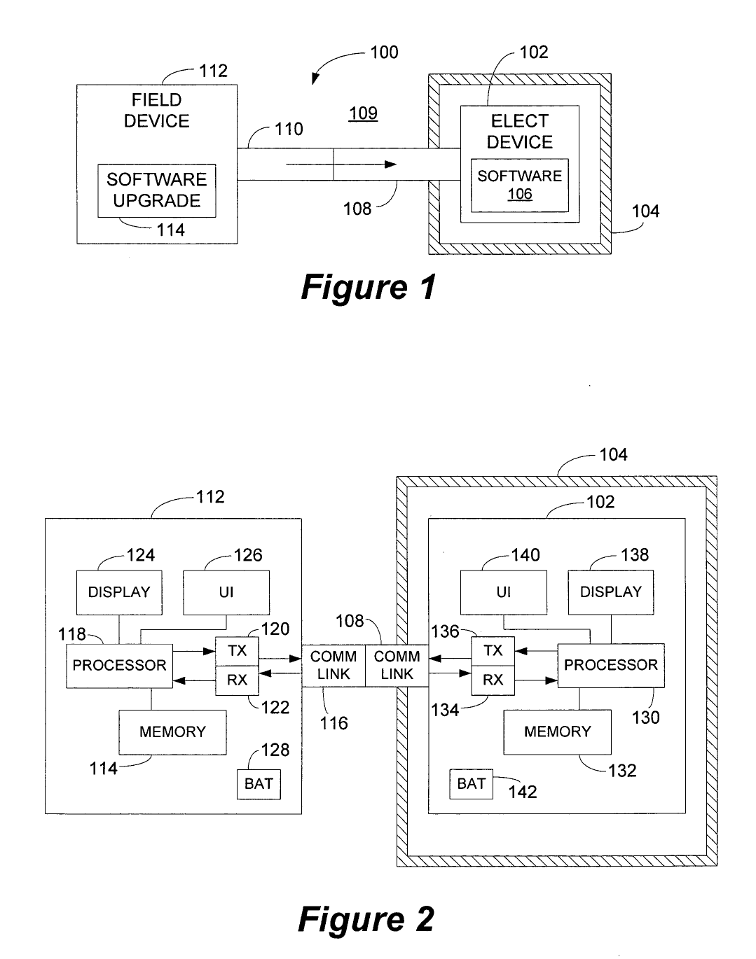

FIG. 1 is a block diagram illustrating the essential components of a system 100 according to the present invention. An electronic device 102 is contained within a package 104. Electronic device 102 may be, for example, a mobile telephone, a PDA, a set top box, or any other device that includes application software or firmware 106. Software 106 will typically be stored in a memory Any type of memory suitable for storing computer program instructions and data may be used. A rewritable non-volatile memory such as, for example, EPROM (Erasable Programmable Read Only Memory), EEPROM (Electrically Erasable Programmable Read Only Memory), Flash memory or NVRAM (Non-Volatile Random Access Memory) will typically be most appropriate.

Package 104 may be any type of appropriate packaging or closure. Typically, the package type will be chosen based on considerations such as protection of the enclosed device, aesthetic appearance, theft-deterrence, cost, recyclability and ease of display. Examples include thermoform plastic enclosures (clamshells), blister packaging, boxes and so on. A data path 108 extends from the enclosed device 102, through package 104, and to the external environment 109 to permit coupling of an external field device 112 via a wired or wireless data link 110. Field device 112 is preferably a two-way communication device and includes a software program, upgrade or patch 114 stored in its memory to be provided to packaged electronic device 102.

FIG. 2 is a block diagram illustrating system 100 in more detail. Field device 112 may be any communication device capable of storing a software program and uploading the program via a communication link 116 to another device (i.e. electronic device 102). Field device 112 will typically include a processor 118 that controls the operation of device 112. Processor 118 may be any suitable central processing unit, general or special purpose microprocessor or digital signal processor.

Memory 114 is connected to processor 118 and contains the software program or patch to be uploaded to device 102. Memory 114 may comprise non-volatile memory devices such as, for example, EPROM (Erasable Programmable Read Only Memory), EEPROM (Electrically Erasable Programmable Read Only Memory), Flash memory, NVRAM (Non-Volatile Random Access Memory, internal and/or removable disks, CD-ROM or DVD-ROM disks. The operating program or instructions for field device 112 itself may be stored in memory 114 as well, or in a separate memory. Field device 112 may also comprise volatile memory such as RAM or DRAM.

A transmitter 120 is coupled to communication link 116 for transmission of data, including the software update stored in memory 114. Preferably, a receiver 122 is also provided for receipt of data from communication link 116, permitting the receipt of feedback data from devices such as device 102. The configuration and operation of receivers and transmitters is well known to those of skill in the art, and need not be explained in detail herein. Device 112 will also typically include a display 124, such as an LCD or CRT monitor, a user interface 126, such as a keyboard and/or trackball/mouse, and a power source 128, such as a battery. Again, the manner of operation of these components of field device 112 is well known, and need not be described in detail herein. Additionally, field device 112 may include other components as appropriate or required beyond those illustrated in FIG. 2.

Communications link 116 is provided for exchange of data with an external device, such as device 102. Importantly, communications link 116 provides the ability to download a software program to electronic device 102. Communication link 116 may be a physical coupling configured to engage a corresponding coupling on device 102, thereby establishing a physical conductive path for data flow. Alternatively, communication link 116 may be an antenna or the like for wireless data transmission to device 102.

For purposes of the present invention, the internal configuration of packaged device 102 is much the same as that of field device 112. Electronic device 102 may be, for example, a mobile telephone, a PDA, a set top box, or any other device that includes application software or firmware 106. Device 102 will typically include a processor 130 that controls the operation of device 102. Processor 130 may be any suitable central processing unit, general or special purpose microprocessor or digital signal processor.

Memory 132 is connected to processor 130 and contains application software or firmware 106. Memory 132 may comprise non-volatile memory devices such as, for example, EPROM (Erasable Programmable Read Only Memory), EEPROM (Electrically Erasable Programmable Read Only Memory), Flash memory, NVRAM (Non-Volatile Random Access Memory, internal and/or removable disks, CD-ROM or DVD-ROM disks, as well as volatile memory such as RAM or DRAM.

A receiver 134 is coupled to communication link 108 for receipt of data, including a software update from field device 112 (via communication link 116). Preferably, a transmitter 136 is also provided for transmitting data over communication link 108, permitting the provision of feedback, status or identifying data to devices such as field device 112. Again, the configuration and operation of receivers and transmitters is well known to those of skill in the art, and need not be explained in detail herein. Device 102 will also typically include a display 138 such as an LCD or CRT monitor, a user interface 140, such as a keyboard and/or trackball/mouse, and a power source 142, such as a battery. Again, the manner of operation of these components of field device 102 is well known, and need not be described in detail herein. Electronic device 102 will also include other components as required for its particular application.

Electronic device 102 is packaged within a package 104. Package 104 may be any type of appropriate packaging or closure. Typically, the package type will be chosen based on considerations such as protection of the enclosed device, aesthetic appearance, theft-deterrence, cost, recyclability and ease of display. Examples include thermoform plastic enclosures (clamshells), blister packaging, boxes and so on. Communications link 108 extends from the enclosed device 102, through package 104, and to the external environment 109 to permit exchange of data with an external device, such as field device 112. Importantly, communications link 108 provides the ability to receive a software program or update from a field device 112, without the requirement of removing device 102 from package 104. Communication link 108 may be a physical coupling configured to engage a corresponding coupling on device 102, thereby establishing a physical conductive path for data flow. Alternatively, communication link 116 may be an antenna or the like for wireless data reception from device 112.

In one implementation, communication link 108 is implemented as a flexible strip or harness with conductive leads coupled directly or indirectly to receiver 134 (and, if present, transmitter 136) and extending from device 102, through appropriate openings in package 104, and into the environment 109 external to package 104. The conductive leads include a data path, for providing exchange of data, such as a software update. In one embodiment, the communications strip may include a power path, for powering the electronic circuitry and memory of device 102 to permit receipt of an update without draining its own internal power source 142.

Power may alternatively be provided by internal battery 142. In one implementation, a medium such as a pull tab is interposed between the battery electrodes so that the device is not normally powered on, thereby preserving the battery. When a software update is desired, the tab may be pulled, powering the phone, and permitting receipt of the update over communication link 108.

In another embodiment, packaging 104 is formed with appropriate holes, underneath which are appropriate connectors (communication link 108) leading to circuitry within electronic device 102. Mating data/power conductors of field device 112 (communication link 116) are inserted into the holes, coupled to the connectors, and the software upgrade 114 downloaded to memory 132 of device 102, supplementing, revising or replacing the software 106 currently stored there. Pogo pins, for example, may be used as the connectors providing a path to electronic device 102.

When packaged devices, such as packaged device 102, are still in a warehouse or other storage facility, hundreds of devices may be stored together on a single palette or other location. In one implementation, flexible strips containing the power/data paths extend from the packages of each device on the palette, and are then coupled to a single (or multiple) common strip. Hence, a software update to all devices on the palette may be provided via connection of a single field device 112 to the common power/data strip. In another embodiment, where different versions or types of devices are stored together on a single palette and connected to a common strip, the field device is able to identify those devices requiring the update and provides the update only to those devices. Each device may have a transmitter, such as transmitter 136, for example, for transmitting indicia to field device 112 indicative of whether it is a device requiring the proffered update. In a still further embodiment, field device 112 may contain multiple updates for multiple external devices, and may provide appropriate updates to appropriate devices based on indicia returned by those devices.

In addition to provision of software upgrades and modifications, the system and method of the present invention may be used for other purposes. The data path provided from the device to the exterior of the package may be used for inventory verification, control and management, for example.

Numerous embodiments of the present invention have been shown and described herein. It should be understood, however, that these have been presented by way of example only, and not as limitations. The breadth and scope of the present invention is defined by the following claims and their equivalents, and is not limited by the particular embodiments described herein.

1. A system for modifying software embedded in a packaged electronic device comprising:
a communications path extending from the electronic device to the exterior of a package containing the electronic device, the communications path configured for coupling to an external device for receipt of modified software.

2. A system as claimed in claim 1, wherein the communications path is contained within a flexible strip.

3. A system as claimed in claim 2, wherein the flexible strip has power and data conductors.

4. A system as claimed in claim 1, and further comprising a tab interposed between battery contacts of the device that may be removed to permit powering of the device during software modification.

5. A system as claimed in claim 1, wherein the communications path is a wireless link.

6. A system for managing an inventory of packaged electronic devices with resident software comprising:
a communications path extending from the resident software to the exterior of a package containing the electronic device, the communications path configured for coupling to an external communications device.

7. A method for updating software contained in a packaged electronic device comprising:
coupling a field device containing a software update to a communications path extending through a package that contains the electronic device;
without removing the electronic device from the package, downloading the software update to the electronic device.
